(19) United States
(12) Patent Application Publication
(10) Pub. No.: US 2009/0101780 A1
(43) Pub. Date: Apr. 23, 2009

(54) FLAT SCREEN TV BRACKET FOR A VEHICLE

(75) Inventors: Larry Revelino, Norco, CA (US); Tibor Olah, Covina, CA (US); Chris Departe, Rancho Cucamonga, CA (US)

Correspondence Address: INSKEEP INTELLECTUAL PROPERTY GROUP, INC, 2281 W. 190TH STREET, SUITE 200, TORRANCE, CA, 90504, US

(73) Assignee: RBW Industries, Inc.

(21) Appl. No.: 11/874,684

(22) Filed: Oct. 18, 2007

(51) Int. Cl. A47B 96/06; G06F 1/16; A47F 5/00

(52) U.S. Cl. 248/274.1; 248/309.1

(57) ABSTRACT

The present invention provides a bracket for supporting a flat screen television. In one embodiment, the bracket includes an adjustable arm that is pivotally mounted to a surface. A locking mechanism prevents the pivotal joint from moving until a user selectively unlocks the pivotal joint. The TV can be mounted on the bracket by a single user by way of a removable, latching mounting member. The mounting member is mounted to the TV prior to mounting, but can easily latch to the bracket later without the need to both hold the TV and fasten it to the bracket.

### BACKGROUND OF THE INVENTION

Thin profile media displays such as televisions or computer monitors utilizing LCD or plasma technologies for example, are becoming increasingly common as prices fall for manufacturing this technology. Due to the thin nature of these screens, mounting brackets have become a particularly desirable method of fixing these media screens to the walls and other structures within the home.

Examples of such mounting brackets include U.S. Application Number 2005/0087661, 2004/0045224, 2003/0080268 and 2002/0079415; the contents of which are hereby incorporated by reference.

While these brackets are ideal for home use, they are less than desirable for use in RV's, trailers, boats, airplanes and other vehicles.

### OBJECTS AND SUMMARY OF THE INVENTION

It is an object of the invention to provide a mounting bracket for a thin profile media display better suited for use within a vehicle.

It is an object of the invention to provide a mounting bracket for thin profile media displays that can be moved to a non-viewing storage position.

It is an object of the invention to provide a mounting bracket for thin profile media displays that can be locked in various positions.

In one preferred embodiment according to the present invention, a thin screen display bracket for a cabinet is provided. The bracket preferably mounts to a side wall of a cabinet or cubical and supports the display by an adjustable arm. The bracket includes a joint with a selectively releasable locking mechanism, allowing the user to secure the display in place and selectively swing the display outward.

In another preferred embodiment according to the present invention, a thin screen display bracket is provided. The bracket allows a display to be moved from a position flat against a wall to a position about 45 degrees with the wall. In this respect, the bracket can be mounted near a wall (e.g., forming a corner) or other object, thereby allowing the user to move the display to a desired viewing location. Additionally, the bracket includes a locking mechanism to lock the display into a plurality of different viewing and storage positions.

In yet another preferred embodiment according to the present invention, a motorized thin screen display bracket is provided which allows the user to raise and lower the display. The bracket includes an actuator that moves a mounting portion vertically while two reinforcement posts provide additional support for the display.

### BRIEF DESCRIPTION OF THE DRAWINGS

FIG. 1 illustrates a perspective view of a display bracket within a cabinet according to a preferred embodiment of the present invention;

FIG. 2 illustrates a perspective view of the bracket of FIG. 1;

FIG. 3 illustrates a top view of the bracket of FIG. 1;

FIG. 4 illustrates a front view of the bracket of FIG. 1;

FIG. 5 illustrates an end view of the bracket of FIG. 1;

FIG. 6 illustrates a perspective view of a display bracket according to a preferred embodiment of the present invention;

FIG. 7 illustrates an exploded perspective view of the display of FIG. 6;

FIG. 8 illustrates a front view of a display bracket according to a preferred embodiment of the present invention;

FIG. 9 illustrates a side view of the display bracket of FIG. 8;

FIG. 10 illustrates a side view of the display bracket of FIG. 8 in an elevated position;

FIG. 11 illustrates a front view of the display bracket of FIG. 8 in an elevated position;

FIG. 12 illustrates an end view of the display bracket of FIG. 8;

FIG. 13 illustrates a front perspective view of the display bracket of FIG. 8;

FIG. 14 illustrates a back perspective view of the display bracket of FIG. 8; and,

FIG. 15 illustrates a view of an actuator of the display bracket of FIG. 8.

### DETAILED DESCRIPTION OF THE INVENTION

While the TV industry has migrated to producing thin panel displays (e.g., LCD or Plasma TV's), many recreational vehicles (RVs) have been slow to adapt to the new designs. Often, RVs include an entertainment cabinet or cubical designed for a large “tube” TV. Thin panel displays typically can not be positioned for optimal viewing within these cabinets since the walls of the cabinet often block much of the viewing angles of the thin panel display.

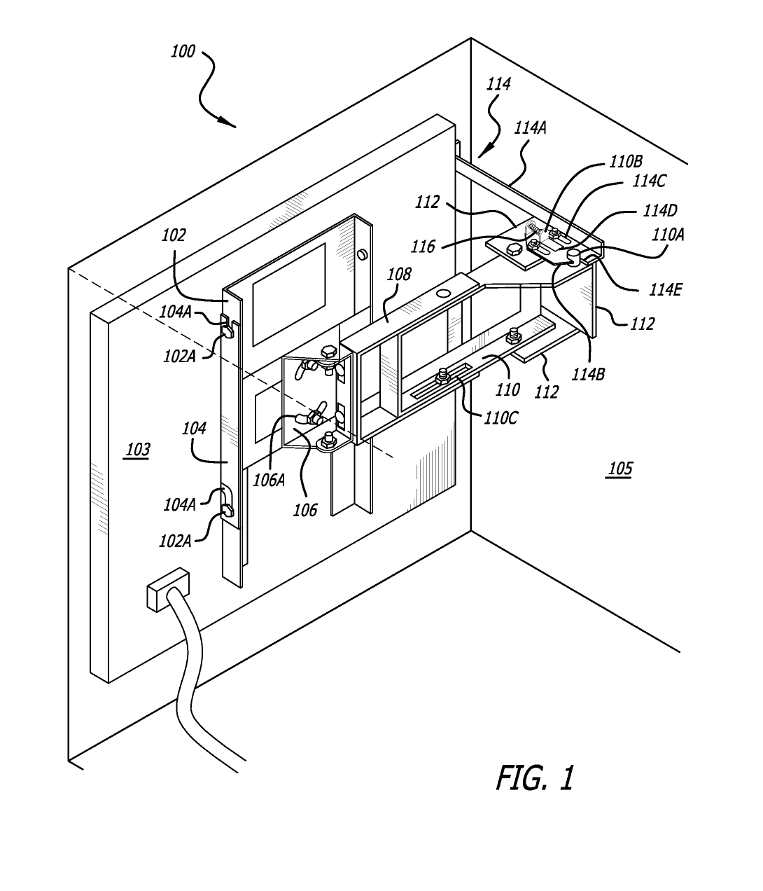

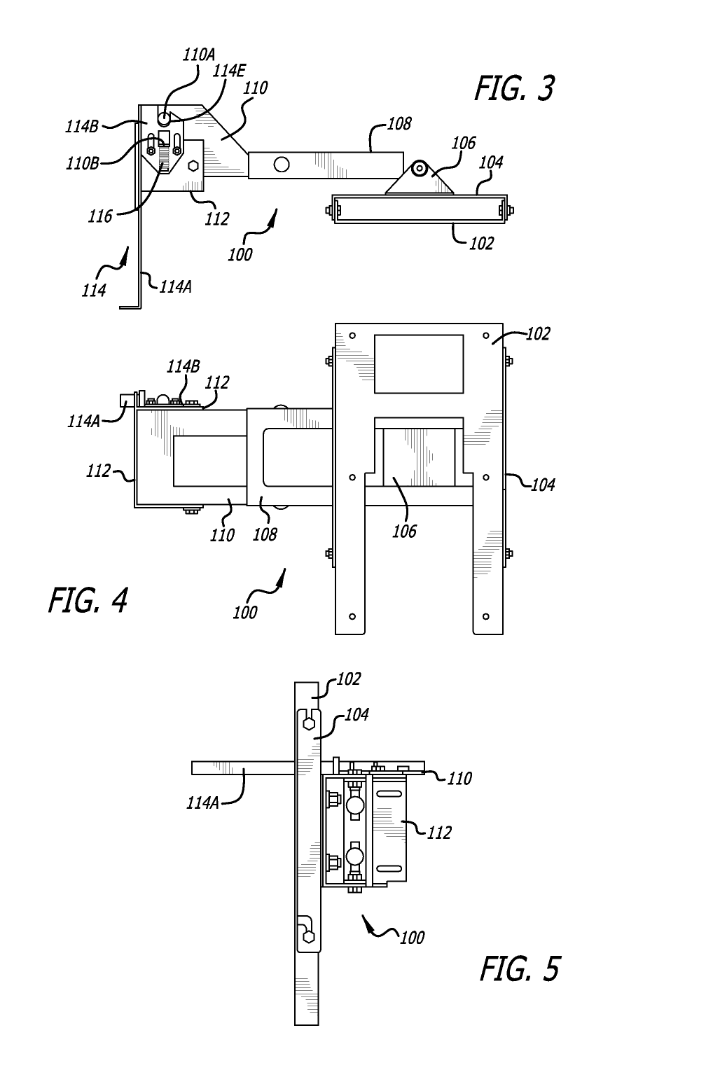

FIGS. 1-5 illustrate a preferred embodiment of a of thin screen display bracket 100. While this bracket 100 can be mounted to any side surface, it is especially suitable for use within an entertainment cabinet or cubical (preferably in a vehicle but also in non vehicle display environments such as a home or office). As best seen in FIG. 1, the display bracket 100 preferably mounts to a side wall 105 of an entertainment cabinet, allowing the thin panel display 103 (seen from the back) to be displayed closer to the front of the cabinet in a position similar to the face of a large tube TV. As described in further detail below, a user can unlock the position of the bracket 100 and swing the thin panel display 103 out from the cabinet for better viewing.

The bracket 100 is fixed (e.g., screws, bolts, etc) to a vertical surface by the mounting member 112. The mounting member 112 is coupled to an intermediate member 110 by bolts, creating a pivotal mount that allows the intermediate member 110 to pivot or hinge.

A sliding member 108 is fixed to the intermediate member 110 by way of bolts positioned through elongated bolt apertures 110C. In this respect, the bolts can be loosened, allowing the sliding member 108 to slide relative to the intermediate member 110, thereby adjusting the horizontal position of the display 108 relative to the vertical mounting surface (e.g., side wall 105).

A horizontal orientation member 106 is pivotally mounted on the end of the sliding member 108. The orientation member 106 includes two arc-shaped slots 106A that each accept a bolt for mounting the H member 104. By loosening the bolts, the H member 104 can be rotated by an amount dictated by the size of the slots 106A. Thus, these slots 106A allow a user to adjust the rotational orientation of part of the bracket 100 and therefore the thin panel display 103 (e.g., to compensate for production variances or irregularities in an entertainment cabinet).

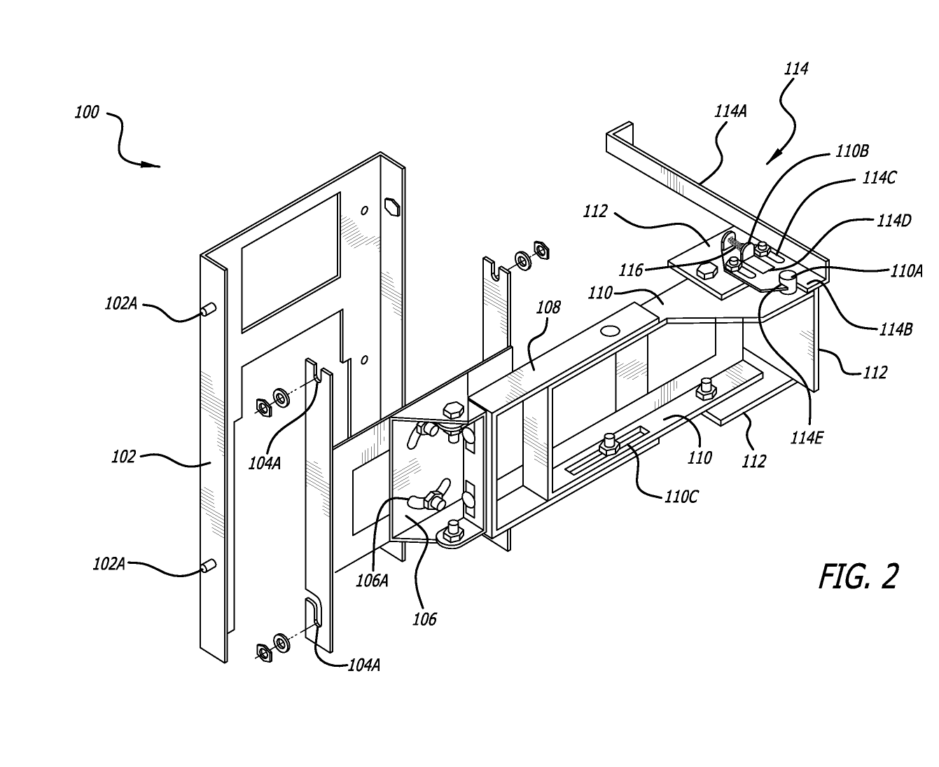

As best seen in FIG. 2, the H member 104 includes upper and lower slots 104A that accept pegs 102A on the display mount 102. The display mount is directly connected to the display 103, for example by screws or bolts. In this respect, a user may first mount the display mount 102 to the display 103, then the display mount 102 can be engaged with the H member 104 (i.e., the pegs 102A engage with slots 104A). The display mount 102 can be further secured by screwing bolts onto threads on the pegs 102A. Hence a single user can mount a display 103 that may otherwise require one person to hold the display 103 and the other to fasten it (e.g., screw in mounting screws).

The bracket 100 further includes a releasable locking mechanism that allows the bracket 100 to pivot, thereby moving the display 103 outward from the entertainment cabinet. The locking mechanism includes a sliding lock member 114 having an elongated handle 114A and a notch engaging portion 114B. Bolts secure the notch engaging portion 114B to the intermediate member 110, allowing the sliding lock member 114 to slide along elongated apertures 114C.

The notch engaging portion 114B includes a notch 114E that is sized to engage a post 110A on the intermediate member 110. The notch 114E is biased against the post 110A by a spring 116 coupled to the notch engaging portion 114B (on the opposite side as the notch 114E) and to a vertical anchor tab 110B that extends from the intermediate member 110 and through a center aperture 114D in the notch engaging portion 114B.

To release the locking mechanism, a user pulls the handle 114A, moving the notch engaging portion 114B away from the post 110A. The intermediate member 110 (and therefore the remaining portion of the bracket 100 and the display 103) can freely pivot about the hinge or bolts of the mounting member 112. When the bracket 100 is pivoted back into place, the post 110A moves against the angled side surface of the notch engaging portion 114B, pushing the sliding locking member 114 away from the post 110A until the notch 114E snaps on to the post 110A.

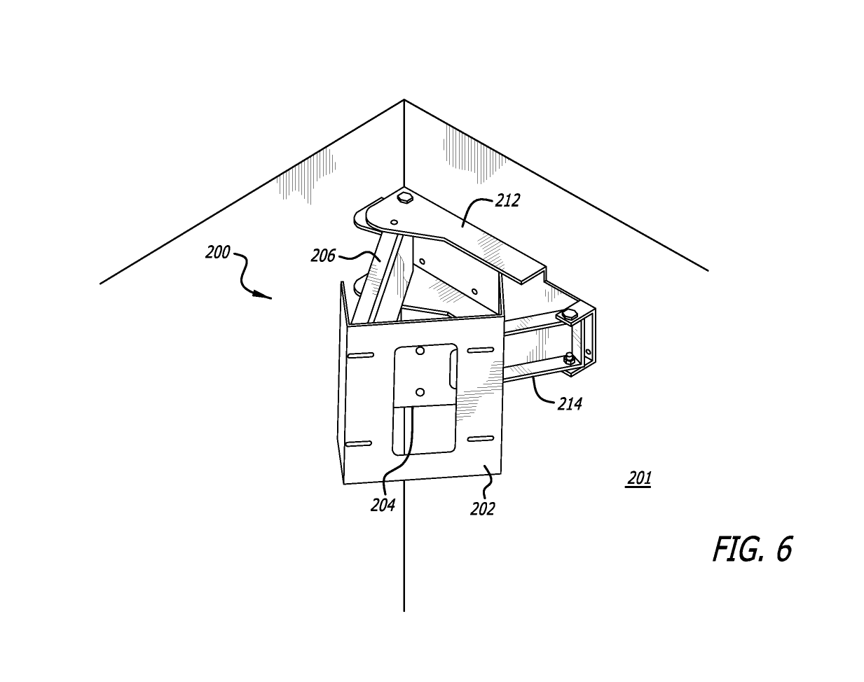

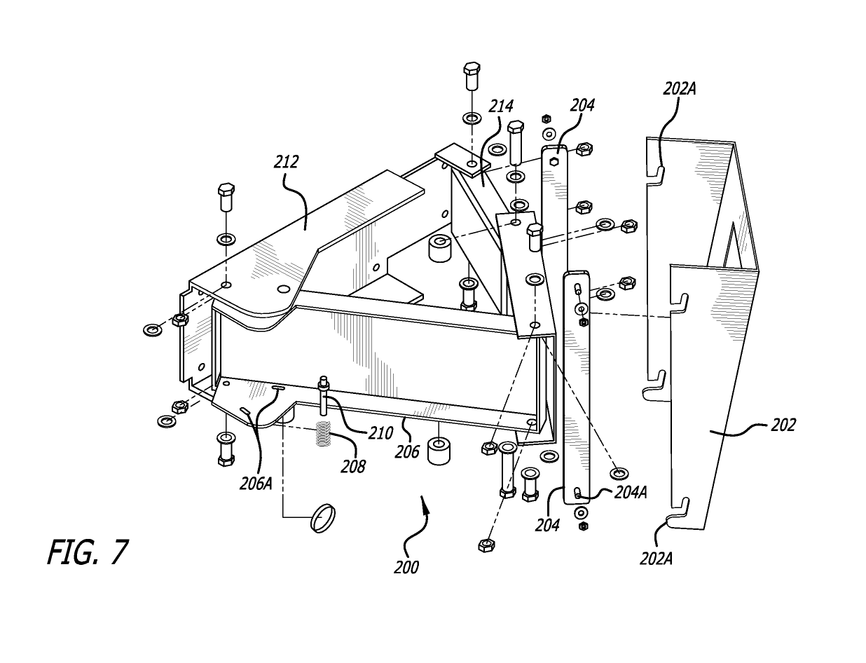

In some environments, such as within an RV or a small room of a house, a user may find it difficult to find space to mount a thin panel display so as to allow optimal viewing angles to the viewer. FIGS. 6 and 7 illustrate a bracket 200 especially suitable for mounting a thin panel display (not shown in these figures) near a wall corner, adjacent a cabinet, or near another wall mounted obstacle. In one configuration, the bracket 200 can be configured to hold the display flat against the wall. In another configuration, the bracket 200 can be configured to present the display at an angle (e.g., about 45 degrees) to the mounting wall 201, as seen in FIG. 6. Thus, the display may be easily viewed, despite being mounted adjacent a corner or other obstacle.

The bracket 200 includes a wall mounting member 212 that is mounted (e.g., with screws) to a wall 201, optionally near an intersection with another wall or other wall mounted obstacle. One end of the wall mounting member 212 is pivotally connected to elongated lateral member 206 and the other end of the wall mounting member 212 is pivotally connected to lateral member 214.

Both the elongated lateral member 206 and the lateral member 214 are also pivotally connected to opposite ends of H member 204. The H member 204 includes a plurality of mounting pegs 204A (preferably 4 pegs 204A) on the sides of the member 204.

A display mounting panel 202 mounts to the back side of a display (not shown). Support slots 202A interlock with the pegs 204A of the H member 204. As with the previously described preferred embodiment, the present preferred embodiment of the bracket 200 allows the user to mount the mounting panel 202 to the display, then attach the panel 202 to the bracket 200. Further, the panel 202 can be locked on to the H member 204 by tightening nuts onto threads on the pegs 204A, against the side of the panel 202.

The bracket 200 also includes a locking mechanism to lock the bracket 200 into a desired position (e.g., at 45 degrees or 0 degrees to the mounting surface). The wall mounting member 212 includes a locking pin 210 and a spring 208 for biasing the pin upwards. The elongated lateral member 206 includes multiple locking apertures 206A which accept the top of the biased pin 210 from through the mounting member 212. In this respect, the user can pull down on the pin 210 (i.e., against the bias) to move the pin 210 out of the locking apertures 206A and thereby freely move the bracket 200 into a desired position. If a locking aperture 206A of the elongated lateral member 206 is then moved over the pin 210, the pin 210 will again move up into the aperture, locking the bracket 200 from movement.

As previously discussed, the bracket 200 preferably includes a first lockable position, seen in FIGS. 6 and 7 where the mounting panel is moved to an orientation of about 45 degrees relative to the mounting surface (e.g., wall 201). The bracket 200 preferably includes a second lockable position in which the mounting panel is moved to an orientation of about 0 degrees relative to the mounting surface. In such an orientation, the elongated lateral member 206 pivots to lie against the mounting member 212, the lateral member 214 pivots to lie against the wall 201, and the H member 204 pivots to lie against the lateral member 214. Thus, the bracket 200 is compacted to a relatively small profile.

In some environments, a user may wish to hide their thin panel display when not in use. Further, environments such as the inside of an RV favor thin and relatively small brackets for supporting a thin panel display.

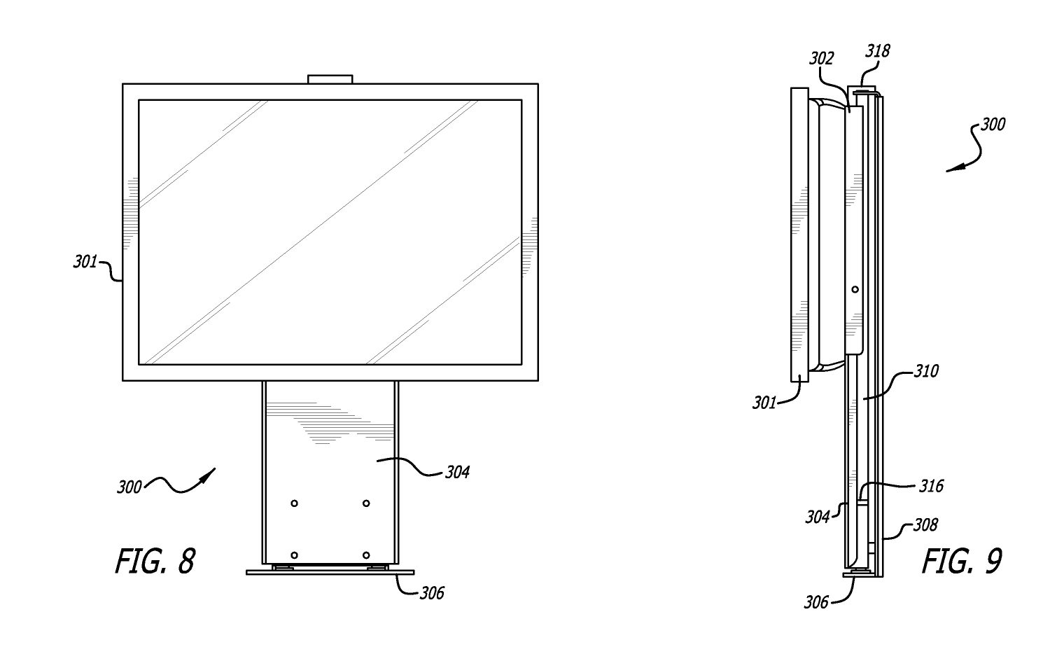

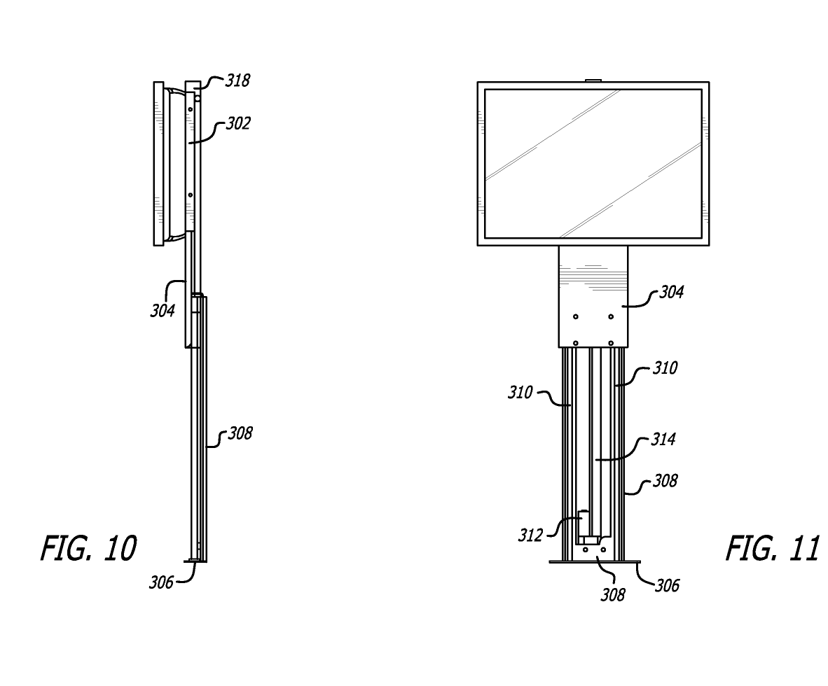

FIGS. 8-14 illustrate a preferred embodiment of a popup display bracket 300 that can vertically move a thin panel display 301 between a lowered position (FIGS. 8 and 9) and a raised position (FIGS. 10 and 11). In this respect, the display 301 and bracket 300 can be hidden within a cabinet, façade, or other structure when lowered and raised out of the structure when in use. Preferably, the design of the bracket 300 allows for a thickness (i.e., depth) of less than 3 inches while still supporting the weight of a thin panel display 301.

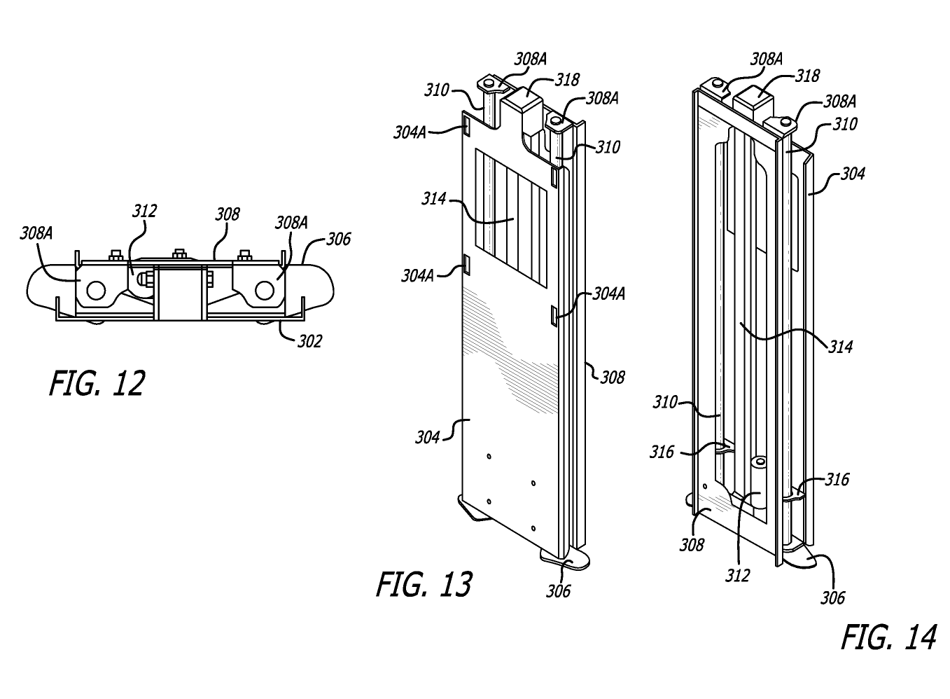

The bracket 300 is mounted (e.g., with screws) to a lower surface by a base member 306, as best seen in FIGS. 12-14. A stationary vertical member 308 is fixed to the base member 306, providing a framework for supporting other components of the bracket 300.

Additional support for the bracket 300 is provided by two vertically positioned rods 310 that are fixed to the base member 306 and at top retaining portion 308A of the vertical member 308. Preferably, these rods are ¾ of an inch in diameter and have a relatively smooth outer surface.

As seen best in FIG. 13, the bracket 300 includes a moving vertical member 304 that is coupled to each of the rods 310 by an enclosure member 316. The enclosure members 306 is fixed to the moving vertical member 306 and is at least partially enclosed around the rods 310 so as to allow the enclosure members 306 to slide along the length of the rods 310. The vertical moving member also includes multiple slots 304A which (similar to the previously described embodiments) allows a user to removably engagable a display mounting member 302 (as seen in FIG. 9). Thus, a user can mount the mounting member 302 to the display 301, then engage (e.g., through protruding tabs on the mounting member 302) the mounting member 302 with the slots 304A of the moving vertical member 304.

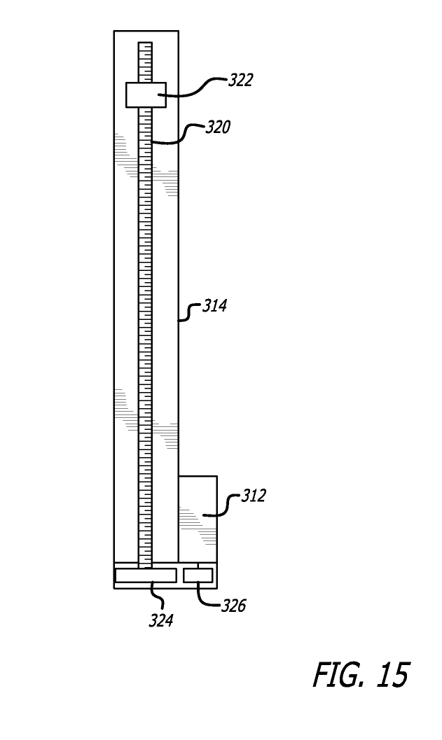

As seen best in FIG. 15, the moving member 304 is moved upward or downward by an actuator comprising a motor 312 engaged with an elongated, vertical acme screw 320 that is partially enclosed in casing 314 but open towards the moving member 304. The bottom of the acme screw 320 includes a gear 324 that intermeshes with motor gear 326, which is ultimately driven by the motor 312. Thus, activating the motor 312 rotates the acme screw 320 in a clockwise or counter clockwise direction.

The moving member 304 is fixed to a “captured” acme nut 322 that is engaged with the acme screw 320 and prevented from rotation. Thus, when the motor 312 is activated, it rotates the acme screw 320, causing the captured acme nut 322 to move up or down the acme screw (depending on the rotation of the acme screw 320). Since the captured nut 322 is fixed to the moving member 304, it is similarly moved upwards or downwards with the nut 322. In this respect, the motor 312 drives the movement of the moving member 304 and ultimately the display 301. Alternately, the actuator may be a pneumatic piston, rack and pinion arrangement or other known actuating mechanisms.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A support bracket for a thin panel display comprising:
a first mounting member for mounting to a surface;
a second elongated member having a first end pivotally coupled to said mounting member;
a third member pivotally mounted to a second end of said second elongated member and configured to connect to said thin panel display; and
a locking mechanism disposed on said first mounting member to releasably engage said second elongated member.

2. The support bracket of claim 1, wherein said locking mechanism further comprises: a lock member comprising a notched area; and, a post member disposed on said second elongated member.

3. The support bracket of claim 2, wherein said locking mechanism further comprises a handle connected to said lock member and wherein said lock member is biased into a locked position.

4. The support bracket of claim 1, wherein said third member further comprises:
a connecting member coupled to said second end of said second elongated member; and
a display mounting member configured to connect to said thin panel display;
wherein said display mounting member removably latches with said connecting member.

5. The support bracket of claim 4, wherein said display mounting member further comprises a plurality of pegs engagable with a plurality of slots; said slots disposed on said connecting member.

6. A support bracket for a thin panel display comprising:
a first mounting member for mounting to a surface;
a second member having a first end pivotally connected to a first end of said first mounting member;
a third member having a first end pivotally coupled to a second end of said second member;
a fourth member having a first end pivotally coupled to a second end of said third member and having a second end pivotally coupled to a second end of said first mounting member.

7. The support bracket of claim 6, wherein said third member is coupled to said thin panel display.

8. The support bracket of claim 7, wherein said third member includes a connecting member and a display mounting member; said display mounting member latching on to said connecting member.

9. The support bracket of claim 6, wherein said support bracket moves between a first position supporting said display parallel with said surface and a second position supporting said display at about 45 degrees with said surface.

10. The support bracket of claim 6, wherein said support bracket further comprises a lock engagable in a first position of said bracket and a second position of said bracket.

11. A support bracket for a thin panel display comprising:
a nonmoving framework having a first end mountable on a lower surface;
an actuator fixed to said nonmoving framework and disposed along a vertical axis of said nonmoving framework;
a support member fixed to said nonmoving framework and disposed along said vertical axis; and
a moving framework coupled to said actuator and to said support member, said moving framework connectable to said thin panel display;
wherein said moving framework is coupled to said actuator so as to increase and decrease a vertical position of said moving framework.

12. The support bracket of claim 11, wherein said actuator further comprises a motor coupled to an elongated acme screw and wherein said moving framework further comprises a captured acme nut engaged with said elongated acme screw.

13. The support bracket of claim 12, further comprising a display mounting member connectable to said thin panel display and engagable with said moving framework.

14. The support bracket of claim 11, wherein said actuator is a pneumatic actuator.

15. The support bracket of claim 11, further comprising a second support member fixed to said nonmoving framework and disposed along said vertical axis.

16. A support bracket for a thin panel display comprising:
a framework connectable to a surface and having a locking adjustment mechanism; and
a display mounting member connectable to said thin panel display;
wherein said display mounting member is removably engagable with said framework.

17. The support bracket of claim 16, wherein said display mounting member further comprises an elongated member engagable with a slot on said framework.

18. The support bracket of claim 16, wherein said framework further comprises an elongated member engagable with a slot on said display mounting member.

19. The support bracket of claim 18, wherein said elongated member is a peg.

20. The support bracket of claim 119, further comprising a nut engagable with a thread of said peg, wherein said nut locks said framework to said display mounting member.
